(19) United States
(12) Patent Application Publication
(10) Pub. No.: US 2022/0334312 A1
(43) Pub. Date: Oct. 20, 2022

(54) OPTICAL FIBER ATTACHMENT TO A PHOTONIC INTEGRATED CIRCUIT USING OPTICAL FIBER-DIRECTED CURING

(71) Applicants: Rochester Institute of Technology, Rochester, NY (US); Air Force Research Laboratory, Rome, NY (US)

(72) Inventors: Stefan Preble, Pittsford, NY (US); Gregory Bond, Newfields, NH (US); John Serafini, Rochester, NY (US); Matthew van Niekerk, North Chili, NY (US); Thomas Palone, Rochester, NY (US); Michael Fanto, Rome, NY (US); Mario J. Ciminelli, Rochester, NY (US)

(73) Assignees: Rochester Institute of Technology, Rochester, NY (US); Air Force Research Laboratory, Rome, NY (US)

(21) Appl. No.: 17/720,989

(22) Filed: Apr. 14, 2022

Related U.S. Application Data
(60) Provisional application No. 63/175,956, filed on Apr. 16, 2021.

(51) Int. Cl. G02B 6/255

(52) U.S. Cl. CPC G02B 6/2555

(57) ABSTRACT

Disclosed is a method and system applicable to attaching a single or multiple optical fibers in sequence to a photonic integrated circuit enabling precise control of optical fibers and/or multiple types of optical fibers and/or at any pitch. The system and method provide optical alignment and in situ attachment of one or more optical fibers to a photonic integrated circuit chip using a photo-curable adhesive, wherein curing light is delivered to the adhesive by the optical fiber being attached.

### CROSS REFERENCE

This application claims the benefit of the filing date of U.S. Provisional Patent Application No. 63/175,956, filed Apr. 16, 2021, which is hereby incorporated by reference in its entirety.

This invention was made with government support under grant No. FA8750-16-2-0140 awarded by the Air Force Research Laboratory and No. 1810282 awarded by the National Science Foundation. The government has certain rights in the invention.

### FIELD

The present disclosure relates to a method and system for optical fiber attachment to a photonic integrated circuit, and in particular for single optical fiber attachment or sequential attachment of multiple optical fibers to a photonic integrated circuit chip using optical fiber-directed curing.

### BACKGROUND

Optical fiber-to-chip attachment has been an ongoing struggle since the conception of photonic integrated circuits (PICs). This problem is even more challenging when coupling multiple optical fibers to a PIC for multi-channel applications. Fiber arrays have been the standard solution however they pose a multitude of disadvantages, including fiber arrays are bulky, expensive, and limited by V-groove precision & fiber uniformity/eccentricity. The bulkiness of the array interferes with electrical inputs/outputs and the weight causes significant mechanical shifts during UV curing that must be compensated for in order to minimize coupling loss. Furthermore, due to compounding misalignments in the positions of the optical fibers in the V-grooves, it is impossible to obtain optimal coupling for every channel.

Alternatively, various passive alignment methods are attractive due to the promise for achieving high volume manufacturing. By pre-etching grooves directly onto the PIC chips, the fibers can be automatically aligned to the on-chip waveguides. However, passive alignment methods require complex chip and/or connector fabrication processes. In addition, various alternative solutions for fiber-to-chip attachment include fiber-to-chip fusion splicing, capped adiabatic tapered fibers, photonic wire bonds and 3D-printed on-chip fiber connectors.

### SUMMARY

In accordance with one aspect of the present invention, there is provided a method for attaching an optical fiber to a photonic integrated circuit, including: actively aligning an end of an optical fiber to a waveguide interface of a photonic integrated circuit chip in the presence of a photo-curable adhesive by monitoring an alignment light transmitted between the end of the optical fiber and the photonic integrated circuit chip to facilitate an optical connection therebetween; and attaching the end of the optical fiber to the photonic integrated circuit chip by transmitting adhesive-curable light down an axis of the optical fiber curing a portion of the photo-curable adhesive while leaving an uncured portion of the photo-curable adhesive surrounding the cured portion, wherein the alignment light is transmitted at a wavelength other than a wavelength capable of curing the photo-curable adhesive.

In accordance with another aspect of the present invention, there is provided a method for attaching an optical fiber to a photonic integrated circuit, including:
dispensing a photo-curable adhesive into contact with an optical fiber and a waveguide interface of a photonic integrated circuit chip;
actively aligning an end of the optical fiber to the waveguide interface of the photonic integrated circuit chip by monitoring an alignment light transmitted between the end of the optical fiber and the photonic integrated circuit chip to facilitate an optical connection therebetween; and
attaching the end of the optical fiber to the photonic integrated circuit chip by transmitting adhesive-curable light down an axis of the optical fiber curing a portion of the photo-curable adhesive while leaving an uncured portion of the photo-curable adhesive surrounding the cured portion, wherein the alignment light is transmitted at a wavelength other than a wavelength capable of curing the photo-curable adhesive.

In accordance with another aspect of the present disclosure, there is provided a system for attaching an optical fiber to a photonic integrated circuit having an alignment light source, multiple optical fibers, a fiber gripper configured to hold the multiple optical fibers, a photonic integrated circuit chip, a photo-curable adhesive, and an alignment light monitoring device configured to monitor an optical connection between the multiple optical fibers and the photonic integrated circuit chip, wherein the improvement is characterized by an adhesive curing light source and a light coupler attachable to each of the multiple optical fibers and in optical communication with the adhesive curing light source.

In accordance with another aspect of the present disclosure, there is provided a method for sequentially attaching multiple optical fibers to a photonic integrated circuit, including:
actively aligning an end of a first one of a plurality of optical fibers to a waveguide interface of a photonic integrated circuit chip in the presence of a photo-curable adhesive by monitoring an alignment light transmitted between the end of the optical fiber and the photonic integrated circuit chip to facilitate an optical connection therebetween;
attaching the end of the first optical fiber to the photonic integrated circuit chip by transmitting adhesive-curable light down an axis of the optical fiber curing a portion of the photo-curable adhesive while leaving an uncured portion of the photo-curable adhesive surrounding the cured portion;
sequentially actively aligning and attaching by transmitting the adhesive-curable light down an axis of the next adjacent optical fiber of the plurality of optical fibers curing a portion of the photo-curable adhesive while leaving an uncured portion of the photo-curable adhesive surrounding the cured portion until each optical fiber of the plurality of optical fibers is attached to the photonic integrated circuit chip, wherein the alignment light is transmitted at a wavelength other than a wavelength capable of curing the photo-curable adhesive; and
curing the uncured portions of the photo-curable adhesive via blanket illumination of the photonic integrated circuit chip with an adhesive-curable light.

These and other aspects of the present disclosure will become apparent upon a review of the following detailed description and the claims appended thereto.

### BRIEF DESCRIPTION OF THE DRAWINGS

FIG. 1A shows optical fibers actively aligned to the chip, FIG. 1B shows attachment of a fiber, FIG. 1C shows active alignment and attachment of a second fiber, FIG. 1D shows attachment of all four fibers, and FIG. 1E shows a blanket curing of the attached fibers;

FIG. 2A is a photo of multiple optical fibers attached at the standard 127 μm pitch, FIG. 2B is a photo of multiple optical fibers attached at the standard 250 μm pitch, and FIG. 2C is a photo of multiple optical fibers attached at arbitrary pitches, to a PIC;

FIG. 3 shows coupling data relating to attachment of optical fibers to a PIC;

FIG. 4 is a schematic of a system, in accordance with an embodiment of the disclosure; and

FIG. 5A shows dispensing of the adhesive on the tips of the optical fibers, FIG. 5B shows dispensing of the adhesive on the chip prior to coarse alignment of the fibers, and FIG. 5C shows dispensing of the adhesive on the chip and fibers after coarse alignment of the fibers.

### DETAILED DESCRIPTION

Disclosed is a method and system applicable to attaching a single or multiple optical fibers in sequence to a Photonic Integrated Circuit (PIC), and particularly to applications that require precise control of optical fibers and/or multiple types of optical fibers and/or at any pitch. The process provides in situ attachment of an optical fiber to a chip using a photo-curable adhesive. Curing light is delivered to the adhesive by the optical fiber, which is being attached to enable specific, deterministic, curing of the adhesive.

Direct independent attachment of multiple, off-the-spool, optical fibers to PIC chips is possible at arbitrary pitches (including commonly used 250 μm and 127 μm pitches). Each fiber is actively aligned by monitoring an optical signal transmitted between the fiber and the chip in the presence of photo-curable adhesive and then attached by directly transmitting curing light down the fiber itself. By targeting the attachment of each fiber, this method allows for independent attachment of multiple fibers, each precisely aligned to a coupler on the chip (with no need for a fiber array).

Advantages of this approach include (1) only the adhesive between the tip of the fiber, and in front of the fiber (a limited distance) is cured, (2) the bond formed is strong enough to hold the tip of the fiber in place while maintaining the desired optical signal, and (3) the light cures all of the epoxy evenly around the tip forming an epoxy “waveguide funnel,” where the cured epoxy has an increased refractive index. This provides microscale, targeted, curing of the epoxy while leaving all of the surrounding epoxy still in a completely liquid state. This fiber attachment method allows for any configuration of fibers to be attached to a chip at any given positioning without altering the relationship of any fiber to chip bond. Consequently, every fiber attachment can be optimized and because each one can be attached individually, there is no longer the need to use fiber arrays in order to realize multiple attached fibers.

Additional advantages of this approach include the ability to interchangeably use different types of optical fibers to attach to the same chip. The optical fibers can be spaced arbitrarily and flexibly adapted to various chip configurations, such as pitch or location. The system does not require any extra on-chip structures. The bulkiness of fiber arrays is also avoided.

In an embodiment, a method for attaching optical fiber(s) to an integrated photonic chip includes dispensing a photo-curable adhesive in contact with the optical fiber(s) and a waveguide interface (which typically includes a coupler designed to match to the optical mode of the optical fiber) of an integrated photonic chip. The end of the optical fiber can be actively aligned to the waveguide interface of the integrated photonic chip in the presence of the adhesive by monitoring an alignment light transmitted between the chip and fiber to facilitate an optical connection therebetween. The end of the optical fiber can be attached to the integrated photonic chip by transmitting curing light down the axis of the optical fiber, curing a portion of the photo-curable adhesive while leaving an uncured portion of the photo-curable adhesive surrounding the cured portion.

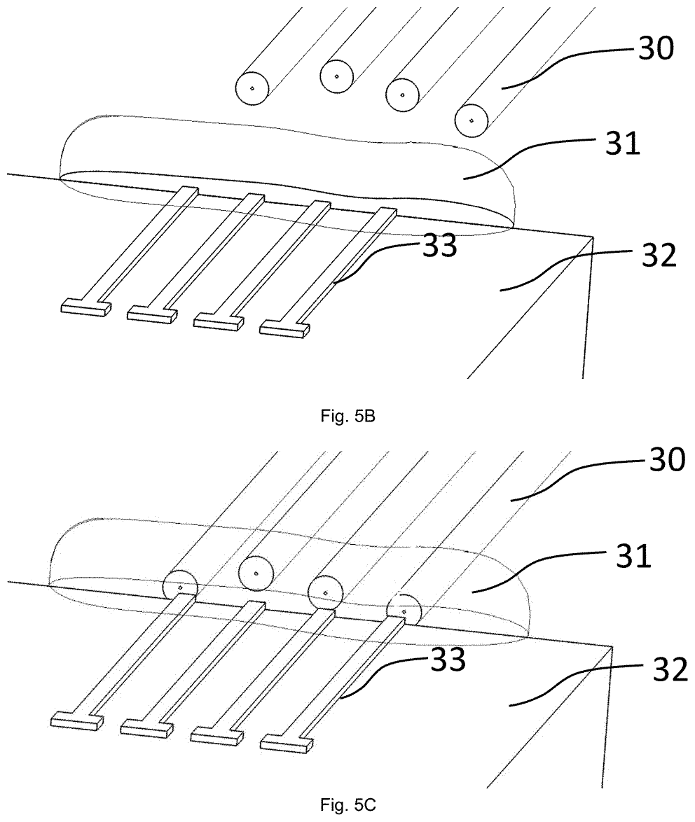

Dispensing the photo-curable adhesive can be accomplished by various methods including, dispensing the adhesive 31 to the chip 32 prior to introduction of the fiber(s) 30 to the chip waveguide 33 as shown in FIG. 5B, dispensing the adhesive 31 to the chip 32 after introduction of the fiber(s) 30 to the chip waveguide 33 as shown in FIG. 5C, or dispensing the adhesive 31 on the end of the fiber(s) 30 prior to introduction of the fiber(s) 30 to the chip waveguide 33 as shown in FIG. 5A. In each case, when the fiber is in close proximity to the chip the adhesive will “wick” between the chip and optical fiber, wetting both, and forming a liquid drop covering both the optical fiber and waveguide interface of the chip. The adhesive has a viscosity suitable for wetting but should not be so viscous as to impede manipulation of the optical fiber alignment. Suitable adhesives include photo-curable adhesives, e.g., UV-curable adhesives. In practice it was found that the UV-curable adhesive EMIUV 3553-HM works well for the application but other optical quality UV-curable adhesives with similar viscosities (hundreds of centipoise) would be suitable for the application.

The optical fiber is actively aligned to waveguide interfaces on the integrated photonic chip by transmitting a light signal through the optical fiber. The alignment light is transmitted at a wavelength other than a wavelength capable of curing the photo-curable adhesive. The optical signal can have a wavelength appropriate for the application of the photonic chip. The optical fiber is aligned by maximizing the amount the light signal coupled to or from the chip. The optical fiber alignment is controlled by mechanically moving the optical fiber using positioners with suitably high precision and stability. In some embodiments, a configurable fiber gripper fixture allows for one fixture to hold any number of fibers at any pitch. This allows multiple fibers to be aligned in subsequent steps to multiple waveguide interfaces on the chip.

The coupling of the light signal transmitted between the end of the optical fiber and integrated photonic chip can be monitored in several different ways. An alignment light from an external laser can be coupled into one end of the optical fiber, transmitted down the fiber, and out the other end of the fiber into the waveguide interface of the chip. The amount of alignment light coupled into the waveguide is monitored using on-chip photodetectors (designed for measurement of optical signals). An external photodetector or camera can be used to indirectly monitor the amount of light coupled from the optical fiber into the waveguide interface on the chip. Light signals on the chip can be observed through intrinsic scattering of the waveguides themselves, engineered light scattering structures or even though other waveguide interfaces. The photonic chip can generate its own light signal (with an on-chip laser, light-emitting device or material). The light propagates to the waveguide interface and is coupled into the end of the optical fiber. It is then transmitted down the fiber, and at the other end a photodetector is used to monitor the optical fiber alignment to the waveguide interface.

The optical fiber is attached to the integrated photonic chip by transmitting curing light down the optical axis of the optical fiber into the photo-curable adhesive at the waveguide interface on the chip. The curing light can be supplied from a LED or laser and coupled into the fiber using a lens or another suitable light coupling element (e.g., the optical fiber could be butted directly into the light source if they are of similar size). With respect to UV-curable adhesive, there are two separate embodiments based on the type of UV light source. In the case of a UV LED, a double-clad optical fiber (such as Thorlabs DCF13) is utilized in order to collect a sufficient amount of the emitted light using a lens into the inner-cladding (diameters of 10-125 microns) of the double-clad optical fiber. The core of the double-clad optical fiber carries the light signal for monitoring the alignment of the fiber to the PIC. A double-clad fiber coupler (such as Thorlabs DC1300LEFA) can be used to combine the UV light (propagating in the inner-cladding) and the light signal (propagating in the fiber core) into a single double-clad fiber. This allows the optical signal alignment to be monitored simultaneously during UV curing. In the case of a UV laser, the coherence of the UV light enables coupling directly into the core of a single mode optical fiber with a lens or another suitable light coupling element (e.g., the optical fiber is directly butted into the lasers emitting facet). This has the advantage that low-cost, standard telecommunication optical fibers (such as Corning SMF-28 or equivalents) can be used. The refractive index of the optical fiber can be matched with the refractive index of the photo-curable adhesive. In both embodiments, the UV light propagates down the optical fiber and exits into the UV-curable adhesive at the waveguide interface of the chip. The UV light exits the fiber at an angle determined by the numerical aperture of the optical fiber embedded in the refractive index of the adhesive. As the UV light cures the adhesive, the refractive index increases, further confining the UV light into a “waveguide funnel” that guides the light until it is absorbed and/or exits the drop of adhesive. The adhesive outside the UV light emanating from the fiber remains in an uncured liquid state.

After all optical fibers are locally attached using the methods described here, the remaining liquid adhesive is cured with a blanket photo illumination that is a standard approach used for the attachment of optical fibers and fiber arrays. For example, UV light delivered by an LED or lamp is focused onto the droplet, curing the liquid adhesive. Optical alignment of the attached fibers can be confirmed post blanket illumination, for example during quality control of manufacturing processes.

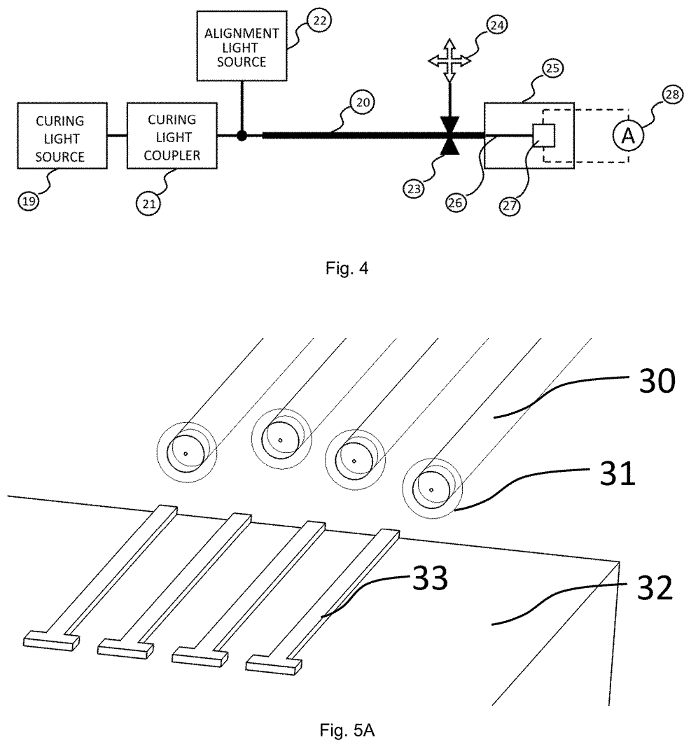

In an embodiment, as shown in FIG. 4, a system for attaching an optical fiber to an integrated photonic chip includes an adhesive-curing light source 19; a least one optical fiber 20; a curing light coupler 21 for coupling light from the curing light source 19 into the at least one optical fiber 20; an alignment light source 22 that can be separately connected to the at least one optical fiber 20; a fiber gripper 23 configured to hold and move the position 24 of the at least one optical fiber 20; an integrated photonic chip 25 with a waveguide 26; and an alignment light monitoring device 27 configured to monitor the alignment light 22 connection between the at least one optical fiber 20 and the integrated photonic chip 25. The alignment light 22 can be electronically 28 monitored.

Suitable photo-curing light sources include UV light sources such as, light emitting diodes (LEDs) used for the specific application of curing optical UV adhesives (such as, Dymax Bluewave or Panasonic Aicure), or UV lasers (such as Coherent Obis 360 nm XT). The wavelength of the curing light source should match the absorption peak of the photo-curable adhesive.

Suitable photo-curing light couplers include UV light couplers including a single lens, multiple lenses, mirror or an overall optical system based on those optical elements for collecting UV light, e.g., 150 nm to 400 nm, from a UV light source (LED or laser) and focusing it into an optical fiber. The lens system has suitable numerical apertures and magnifications for collecting and focusing the UV light.

Suitable alignment light sources for generating and monitoring the optical signal transmitted between the fiber and the chip for monitoring and optimizing the optical connection during fiber attachment include lasers, optical amplifiers and light emitting diodes. The alignment light source can have a wavelength other than a wavelength capable of curing the photo-curable adhesive, e.g., 400 nm to 1600 nm, and is transmissible through the PIC chip waveguides. PIC chips used for telecommunication applications will use an alignment light source with wavelength at telecommunication frequencies, e.g., 1250 nm to 1600 nm. PIC chips designed for operation at visible and NIR wavelengths, e.g., 400 nm to 1000 nm, will use waveguide materials that are transparent at visible wavelengths, such as, glass, silicon nitride, aluminum nitride and other oxides and semiconductors with suitably large bandgaps.

Multimode or double-clad optical fibers (such as Thorlabs DCF13) are suitable for collecting light from UV LEDs. Single mode (SMF28) and polarization maintaining (PM 1550) optical fibers are suitable for collecting light from UV lasers.

Optical lenses with a numerical aperture sufficient for the optical fiber mode being coupled into are suitable for coupling the UV light. The optical lens should have near-diffraction limited performance in order to maximize the coupling efficiency.

Integrated photonic chips with waveguides are suitable for use in the disclosure. The waveguides may include any material that is transparent at the optical signal wavelength but do not need to be transparent at UV wavelengths. The integrated photonic chips may have photodetectors for monitoring the optical signal or can have structures that scatter light for observation with an external photodetector or camera.

Practice of the method and apparatus utilizes fiber grippers or fixturing for manipulating optical fibers and devices for generating and monitoring light signals known to those of skill in the art.

The disclosure will be further illustrated with reference to the following specific examples. It is understood that these examples are given by way of illustration and are not meant to limit the disclosure or the claims to follow.

### Example 1—Targeted UV Fiber Attachment

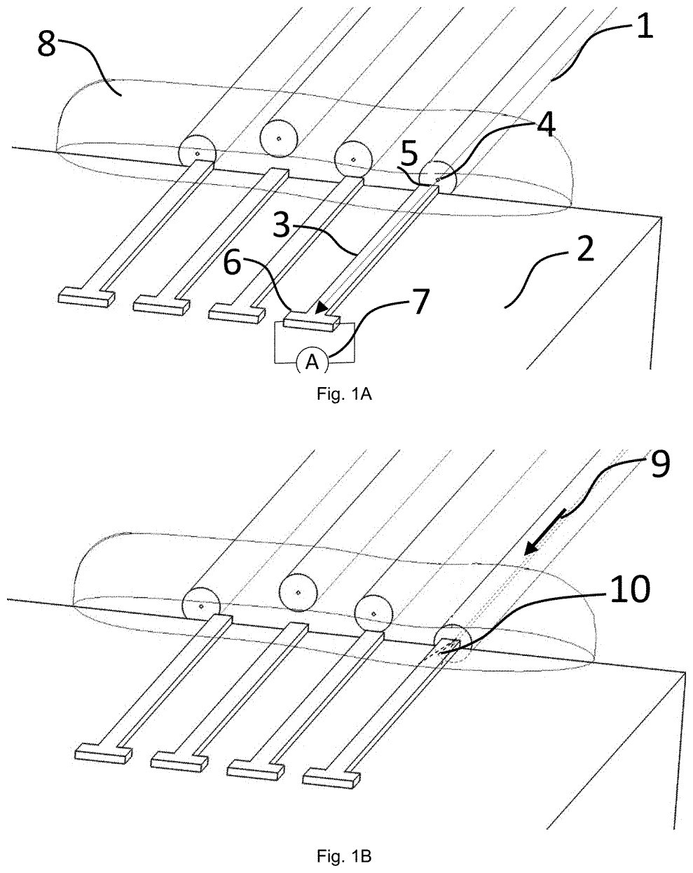

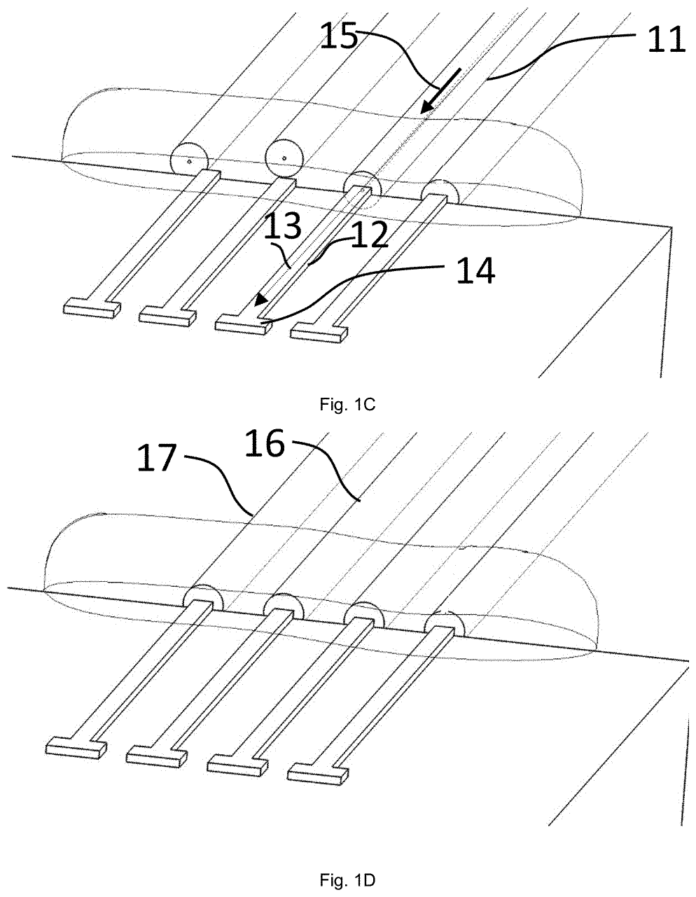

A UV-cured fiber attachment process was performed with four optical fibers as shown in FIGS. 1A-1E. FIG. 1A illustrates the coarse presentation of the four optical fibers to a PIC chip in the presence of a UV curable adhesive. The four optical fibers were held close to the PIC chip 2 by a fiber holder fixture (not shown). FIG. 1A shows EMIUV 3553-HM epoxy adhesive 8 dispensed onto the chip, which wicks along the edge of the chip 2. A first fiber 1 was actively aligned with a corresponding first waveguide 3 on the PIC chip 2 by transmitting a laser signal 5 down the optical fiber core 4. The signal coupling 5 from the first fiber 1 to the first waveguide 3 on the chip 2 was monitored by measuring the photocurrent of the laser signal 5 with an on-chip photodetector 6 connected to the first waveguide 3. The photocurrent was monitored off the chip 2 electrically by a monitor 7 in milli Amps. FIG. 1B shows UV light 9 coupled from a laser using a lens transmitted down the first fiber 1, and into the adhesive 8. The UV light 9 cures the adhesive 10 directly in front of the fiber 1 and attaches the fiber 1 in place to the edge of the chip 2. The optical coupling from the fiber to chip was verified by measuring the photocurrent from monitor 7 produced by the photodetector 6 from the laser signal 5 propagating down optical fiber 1 by the procedure shown in FIG. 1A. The resulting bond was strong while the natural flexibility of the fiber 1 itself allows for the fiber holder fixture holding all of the fibers to be laterally and vertically actuated without affecting the laser signal 5. Through this lateral and vertical adjustment, the adjacent second fiber 11 was moved and actively aligned with the adjacent second waveguide 12, shown in FIG. 1C. The bond between the fiber 1 and the chip 2 was strong enough to support movement of the fiber holder fixture in the x, y, and z directions without disrupting the optical signal 5 propagating down optical fiber 11. FIG. 1C shows the laser signal 13 transmitted through the second fiber 11 while the first fiber 1 remained attached in place. The laser signal 13 transmitted into the second waveguide 12 was monitored through the photodetector 14. UV light 15 coupled from a laser using a lens was transmitted down the second fiber 11, and into the adhesive 8. The UV light 15 cures the adhesive 8 directly in front of the second fiber 11 and attaches the fiber 11 in place to the edge of the chip 2. The optical coupling of the first two optical fibers 11 and 1 to the waveguides on the chips was verified by transmitting laser signals consecutively down each fiber and monitoring the electrical signal on the respective photodetectors 6 and 14. FIG. 1D illustrates all four fibers attached to the chip 2 by the same process described above repeated on the 3rd fiber 16 and 4th fiber 17. FIG. 1 E shows after all four fibers were attached, the surrounding adhesive was cured via blanket illumination of the chip 2 with a UV light source 18, thoroughly bonding the four fibers to the chip 2.

### Example 2

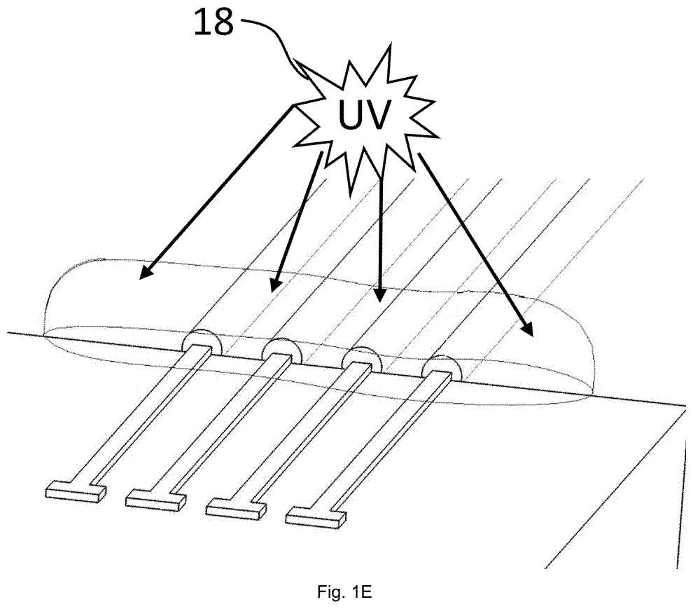

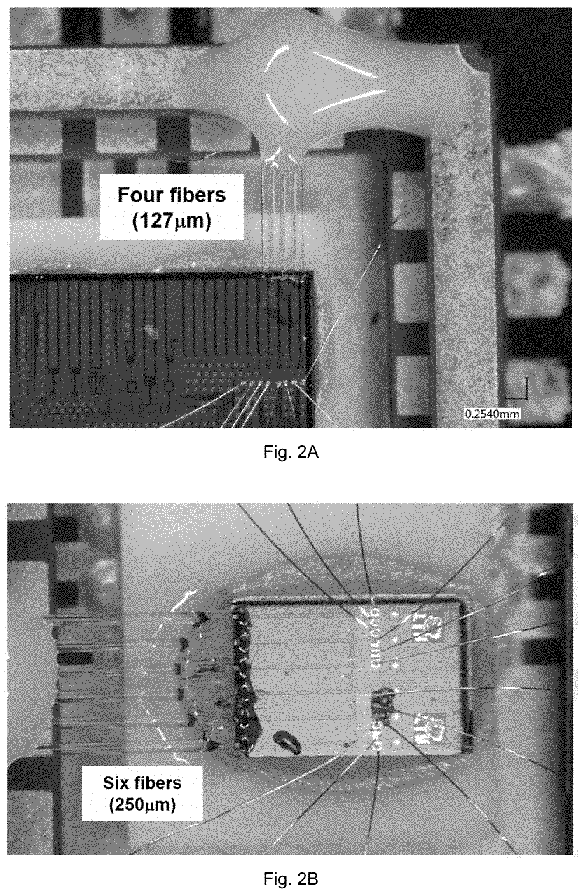

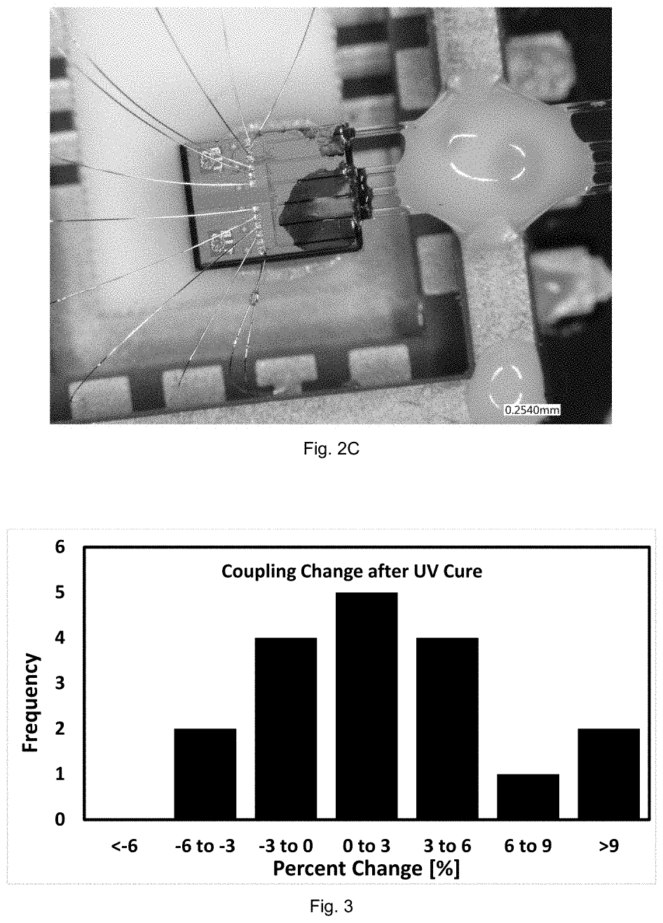

A 127 μm pitch attachment of 4 optical fibers to a PIC was performed according to the process described in Example 1 and shown in FIG. 2A. A 250 μm pitch attachment of 6 optical fibers to a PIC was performed according to the process described in Example 1 and shown in FIG. 2B. An arbitrary attachment of optical fibers at different pitches was performed according to the process described in Example 1 and shown in FIG. 2C. After dispensing a standard UV cure adhesive, each fiber was actively aligned to the PIC and then attached in place by directly transmitting UV (365 nm) light down the fiber itself. The attachment was sufficiently strong, allowing it to be repeated for each and every fiber, enabling multiple optical fibers to be attached at the standard 127 μm and 250 μm pitches, and arbitrary pitches.

### Example 3

18 fiber attachments to multiple chips at different pitches were performed in accordance with the disclosed process. The percent change in coupling from start to finish of the process was measured for the 18 fiber attachments. The results are shown in FIG. 3, which indicates an average signal increase after the final blanket UV cure of 2.6% with a standard deviation of 5.6%. The slight increase in coupling is attributed to a shrinkage of the cured adhesive which causes more intimate contact with the chip facet. The outliers are attributed to the manual alignment setup. The strength of the bond formed by the UV attach proved to be enough to hold each fiber in place while the fiber holder fixture was being manipulated. This method created a robust package that held the fibers in alignment despite being handled multiple times. No degradation in the optical fiber was observed due to the UV cure, likely because the time required to cure was relatively short (tens of seconds to two minutes).

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. A method for attaching an optical fiber to a photonic integrated circuit, comprising:
actively aligning an end of an optical fiber to a waveguide interface of a photonic integrated circuit chip in the presence of a photo-curable adhesive by monitoring an alignment light transmitted between the end of the optical fiber and the photonic integrated circuit chip to facilitate an optical connection therebetween; and
attaching the end of the optical fiber to the photonic integrated circuit chip by transmitting adhesive-curable light down an axis of the optical fiber curing a portion of the photo-curable adhesive while leaving an uncured portion of the photo-curable adhesive surrounding the cured portion, wherein the alignment light is transmitted at a wavelength other than a wavelength capable of curing the photo-curable adhesive.

2. The method of claim 1, wherein the adhesive-curable light is UV light and the photo-curable adhesive is a UV-curable adhesive.

3. The method of claim 1, further comprising dispensing the photo-curable adhesive onto the waveguide interface by applying the photo-curable adhesive to the end of the optical fiber prior to actively aligning the optical fiber.

4. The method of claim 1, further comprising dispensing the photo-curable adhesive onto the waveguide interface.

5. The method of claim 4, wherein the photo-curable adhesive is dispensed onto the waveguide interface in the presence of the optical fiber.

6. The method of claim 1, wherein monitoring the optical connection comprises detecting an optical signal with a photodetector internal to the photonic integrated circuit chip.

7. The method of claim 1, wherein monitoring the optical connection comprises detecting an optical signal with a photodetector external to the photonic integrated circuit chip.

8. The method of claim 1, further comprising actively aligning an end of a second optical fiber to a second waveguide interface of the photonic integrated circuit chip in the presence of the photo-curable adhesive by monitoring the alignment light transmitted between the end of the optical fiber and the photonic integrated circuit chip to facilitate an optical connection therebetween; and
attaching the end of the second optical fiber to the photonic integrated circuit chip by transmitting the adhesive-curable light down an axis of the second optical fiber curing a portion of the photo-curable adhesive while leaving an uncured portion of the photo-curable adhesive surrounding the cured portion.

9. The method of claim 8, further comprising actively aligning an end of a third optical fiber to a third waveguide interface of the photonic integrated circuit chip in the presence of the photo-curable adhesive by monitoring the alignment light transmitted between the end of the third optical fiber and the photonic integrated circuit chip to facilitate an optical connection therebetween; and
attaching the end of the third optical fiber to the photonic integrated circuit chip by transmitting the adhesive-curable light down an axis of the third optical fiber curing a portion of the photo-curable adhesive while leaving an uncured portion of the photo-curable adhesive surrounding the cured portion.

10. The method of claim 9, wherein spacing between the first and second optical fibers is different than the spacing between the second and third optical fibers.

11. The method of claim 9, further comprising curing the uncured portions of photo-curable adhesive on the photonic integrated circuit chip.

12. A system for attaching multiple optical fibers to a photonic integrated circuit, having an alignment light source, multiple optical fibers, a fiber gripper configured to hold the multiple optical fibers, a photonic integrated circuit chip, a photo-curable adhesive, and an alignment light monitoring device configured to monitor an optical connection between the multiple optical fibers and the photonic integrated circuit chip, wherein the improvement comprises an adhesive curing light source and a light coupler attachable to each of the multiple optical fibers and in optical communication with the adhesive curing light source.

13. The system of claim 12, wherein at least one of the multiple optical fibers is a single mode optical fiber.

14. The system of claim 12, wherein at least one of the multiple optical fibers is a multimode optical fiber.
